(19) United States
(12) Patent Application Publication
(10) Pub. No.: US 2021/0205969 A1
(43) Pub. Date: Jul. 8, 2021

(54) FASTENER DRIVING TOOL

(71) Applicant: Chongqing Hybest Tools Group Co., Ltd., Chongqing (CN)

(72) Inventor: Yimin ZHU, Chongqing (CN)

(21) Appl. No.: 17/140,408

(22) Filed: Jan. 4, 2021

(30) Foreign Application Priority Data
Jan. 6, 2020 (CN) 202010010469.9

(51) Int. Cl. B25C 1/04; B25C 1/00

(52) U.S. Cl. CPC B25C 1/047; B25C 1/008

(57) ABSTRACT

A fastener driving tool includes a rack-like striking rod and a rod returning mechanism. The rod returning mechanism includes a motor and a pinion receiving a torque from the motor. The pinion has a teeth section and a non-toothed section. During a driving stroke movement of the striking rod, the pinion is rotated by the motor to bring the non-toothed section into facing the teeth of the striking rod. The pinion is subsequently rotated by the motor to bring the teeth section into engagement with the teeth of the striking rod so as to move the striking rod upwardly back to its driving position. The teeth section has a movable tooth which is resiliently movable in a radial direction so as to facilitate meshing engagement of the teeth section with the teeth of the striking rod to smoothly return the striking rod.

### CROSS-REFERENCE TO RELATED APPLICATION

This application claims priority of Chinese Patent Application No. 202010010469.9, filed on Jan. 6, 2020.

### FIELD

The disclosure relates to a fastener driving tool, and more particularly to a fastener driving tool with a rod returning mechanism to lift a striking rod back to its driving position.

### BACKGROUND

A conventional fastener driving tool generally utilizes a spring for moving a striking rod back to its driving position. In order to prevent malfunction of the spring during the returning stroke of the striking rod, a handheld fastener striking tool as disclosed in CN110253504A is designed to include an energy storing mechanism which has a cylinder disposed in a housing, and a piston connected with a rack-like striking rod to be operable by a compressed gas to bring the striking rod into a driving stroke movement. A lifting mechanism applied includes a driving pinion driven by a motor and coupled with the striking rod through a transmitting wheel to intermittently engage with the striking rod so as to make a linear movement of the striking rod back to its driving position, and a guiding wheel disposed to engage with the opposite side of the striking rod to guide the driving stroke movement and the returning movement in an up-down direction. However, such lifting mechanism has a complicated structure which is bulky and increases receiving spaces in the housing.

### SUMMARY

Therefore, an object of the disclosure is to provide a fastener driving tool that can alleviate at least one of the drawbacks of the prior art.

According to the disclosure, the fastener driving tool includes a rack-like striking rod and a rod returning mechanism. The striking rod extends along an up-down direction and is operable by a compressed gas to conduct a driving stroke movement in the up-down direction for driving a fastener into a workpiece. The striking rod has a plurality of teeth arranged along the up-down direction. The rod returning mechanism includes a motor and a pinion receiving a torque from the motor to rotate about an axis that is transverse to the up-down direction. The pinion has a periphery which includes a teeth section that is engageable with the teeth of the striking rod, and a non-toothed section that is remote from the teeth of the striking rod such that, during the driving stroke movement of the striking rod, the pinion is rotated by the motor to bring the non-toothed section into facing the teeth of the striking rod so as not to engage with the striking rod, and subsequent to permit the driving stroke movement of the striking rod. The pinion is rotatable by the motor to bring the teeth section into engagement with the teeth of the striking rod so as to move the striking rod upwardly back to its driving position. The teeth section has a movable tooth which is resiliently movable in a radial direction relative to the axis so as to facilitate meshing engagement of the teeth section with the teeth of the striking rod to smoothly return the striking rod back to its driving position.

### BRIEF DESCRIPTION OF THE DRAWINGS

Other features and advantages of the disclosure will become apparent in the following detailed description of the embodiments with reference to the accompanying drawings, of which:

FIG. 1 is a schematic sectional view illustrating a first embodiment of a fastener driving tool according to the disclosure in a state when a piston is at a bottom-most position;

FIG. 2 is a schematic sectional view illustrating a state when a movable tooth of a pinion is to be engaged with a rack-like striking rod;

FIG. 3 is a schematic sectional view illustrating a state when the pinion is abnormally engaged with the striking rod;

FIG. 4 is a cutaway perspective view illustrating the pinion of the first embodiment;

FIG. 5 is a perspective view of the movable tooth of the pinion of the first embodiment;

FIG. 6 is a schematic sectional view of the fastener driving tool of the first embodiment;

FIG. 7 is a fragmentary, sectional view of the first embodiment;

FIG. 8 is a schematic sectional view of a second embodiment of the fastener driving tool according to the disclosure;

FIG. 9 is a fragmentary, sectional view of the second embodiment;

FIG. 10 is a schematic sectional view of the first embodiment taken from, another angle, and illustrating a state when the piston is at the top-most position;

FIG. 11 is a schematic sectional view of the first embodiment, illustrating a state when the piston is at the bottom-most position;

FIG. 12 is an enlarged view of a circle portion in FIG. 6, illustrating that a rotary knob is loosened;

FIG. 13 is an enlarged view similar to FIG. 12, illustrating that the rotary knob is tightened;

FIG. 14 is a rear view of the fastener driving tool;

FIG. 15 is a fragmentary perspective view illustrating a gas regulating mechanism of the fastener driving tool;

FIG. 16 is a cutaway perspective view illustrating a pinion of a modified embodiment;

FIG. 17 is a perspective view of a movable tooth of the pinion of the modified embodiment;

FIG. 18 is a perspective view illustrating a pinion of another modified embodiment; and

FIG. 19 is a cutaway perspective view of the pinion.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

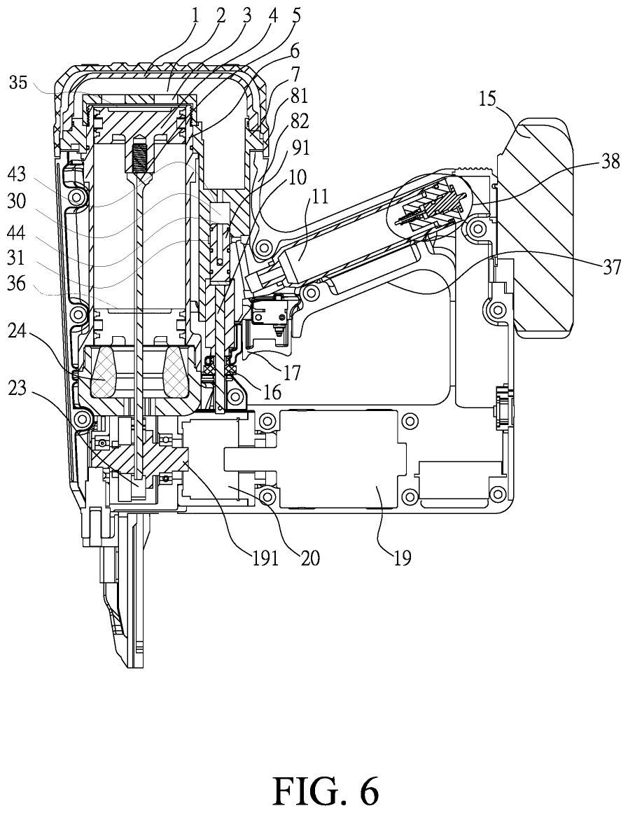

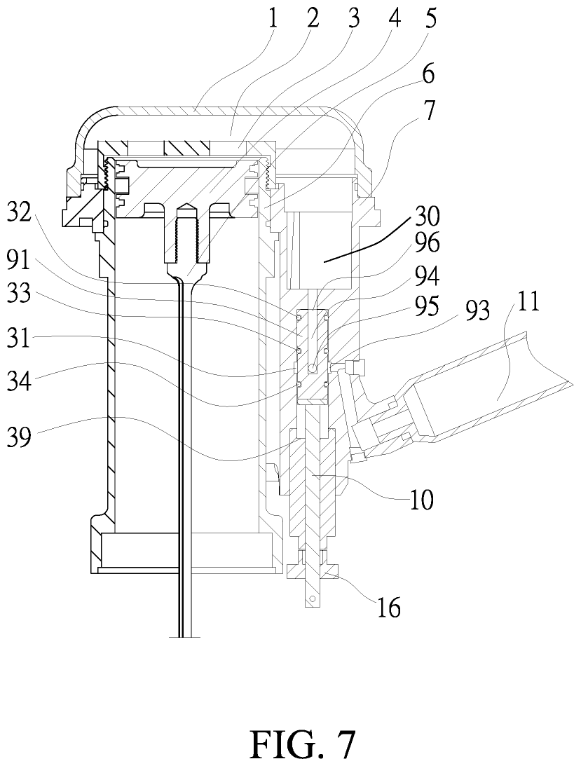

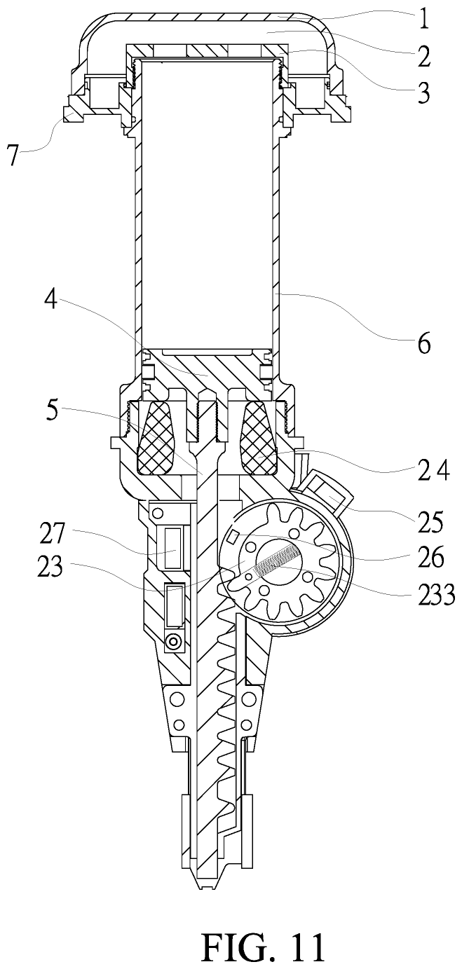

Referring to FIGS. 6, 7, 10 and 11, a fastener driving tool according to the disclosure includes a housing in which a cylinder 6, a rack-like striking rod 5 and a driving mechanism are disposed. The striking rod 5 extends along an up-down direction, and is connected with a piston 4 which is movably disposed in the cylinder 6. The driving mechanism is operable to drive the movement of the piston 4 by a compressed gas to conduct a driving stroke movement of the striking rod 5 in the up-down direction for driving a fastener into a workpiece. The driving mechanism includes a gas storage chamber 2 which is in communication with the cylinder 6, and in which the compressed gas is filled and forced into the cylinder 6. The gas storage chamber 2 is in the form of a compartment or channel formed in a vessel wall 7. A gas supply cylinder 11 is disposed for supplying a compressed gas to the gas storage chamber 2. A valve mechanism is disposed between the gas storage chamber 2 and the gas supply cylinder 11 for controlling the gas flow in a connecting passage interconnecting the gas storage chamber 2 and the gas supply cylinder 11. The valve mechanism includes a valve 91 disposed in the connecting passage and connected with a valve rod 10 such that the valve rod 10 is operable to move the valve 91 axially relative to the connecting passage to open and close a valve seat in the connecting passage. The connecting passage includes a valve moving chamber 30 with an upper end in communication with the gas storage chamber 2, a gas intake port 93 formed in the vessel wall 7, and a conduit 94 formed in the valve 91. The conduit 94 has a conduit outlet 96 formed at an upper end thereof and a conduit inlet 95 formed in a lateral wall thereof. Upper and middle seal rings 32, 33 are sleeved around the valve 91 and disposed above the conduit inlet 95, and a lower seal ring 34 is sleeved around the valve 91 and disposed below the conduit inlet 95. Hence, when the upper and middle seal rings 32, 33 are located above the gas intake port 93 (as shown in FIG. 7), the valve seat of the connecting passage is opened. When the valve 91 is moved axially to locate the middle and lower seal rings 33, 34 below the gas intake port 93 and the upper seal ring 32 above the gas intake port 93 (as shown in FIG. 6), the valve seat is closed to interrupt communication between the gas supply cylinder 11 and the gas storage chamber 2.

The vessel wall 7 further has a recess 31 in communication with the gas intake port 93, and a lower stage 39 for limiting a downward movement of the valve such that an upper of the valve 91 performs a reciprocating movement between upper and lower valve stop points 43, 44.

The valve rod 10 may be in the form of a threaded rod or a pull rod. In this embodiment, the valve rod 10 is a threaded rod. A rotary knob 16 is operable to move the valve rod 10 and the valve 91 upward to open the valve seat of the connecting passage. In this open state, the compressed gas in the gas supply cylinder 11 flows and is filled in the gas storage chamber 2 through the air intake port 93, the recess 31, the conduit inlet 95, the conduit 94, the conduit outlet 96 and the valve moving chamber 30. Rotation of the rotary knob 16 in an opposite direction results in downward movement of the valve rod 10 and the valve 91 to block the connecting passage and stop filling of the compressed gas in the gas storage chamber 2.

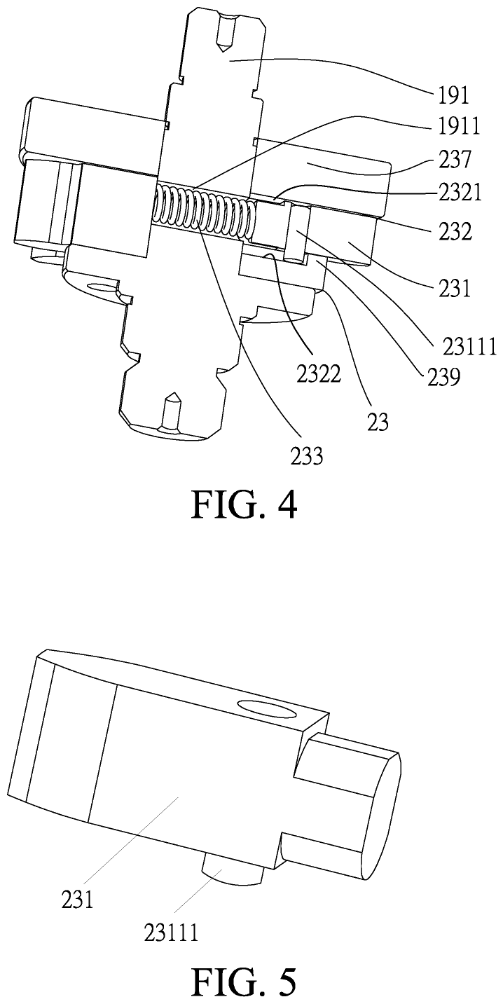

A rod returning mechanism is disposed within the housing, and includes a motor 19 and a pinion 23 receiving a torque from an output shaft of the motor 19 to rotate about an axis that is transverse to the up-down direction. Specifically, the pinion 23 is mounted on a driving shaft 191 which is rotatably supported on a support plate 237 (see FIG. 4) to serve as the axis of the pinion 23. The striking rod 5 has a plurality of teeth arranged along the up-down direction. The pinion 23 has a periphery which includes a teeth section that is engageable with the teeth of the striking rod 5, and a non-toothed section that is remote from the teeth of the striking rod 5. Once the pinion 23 is driven by the motor 19 to be disengaged from the striking rod 5, the striking rod 5 is permitted to conduct the driving stroke movement by the compressed gas. The rotation of the pinion 23 is kept by means of driving of the motor 19 during the driving stroke movement. When the driving stroke movement is finished, the piston 4 stops at a lower piston stop point 36, and the pinion 23 meshes with the striking rod 5 to move the striking rod 5 upward back to its driving position.

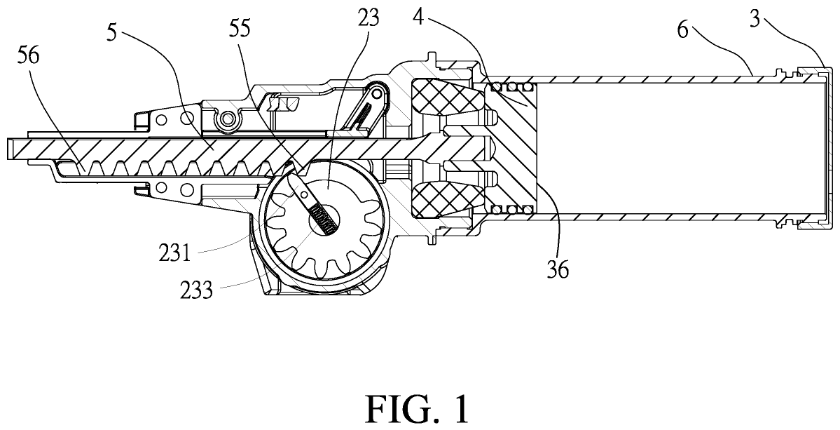

With reference to FIGS. 1 to 5, the teeth section of the pinion 23 has a movable tooth 231 which is resiliently movable in a radial direction relative to the axis. The movable tooth 231 is adjoined to the non-toothed section. The pinion 23 has a slide slot 232 in which the movable tooth 231 is received and slidable in the radial direction, and a compression spring 233 attached to the movable tooth 231 to bias the movable tooth 231 toward the striking rod 5 in the radial direction.

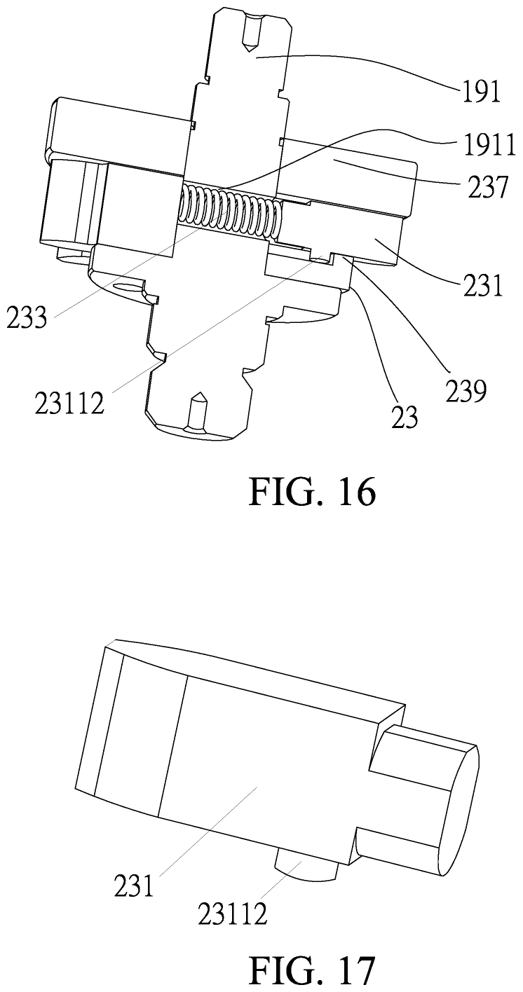

In this embodiment, as shown in FIGS. 4 and 5, the pinion 23 has two radial walls 2321, 2322 which extend in the radial direction to define the slide slot 232 therebetween. The driving shaft 191 has a spring receiving chamber 1911 in spatial communication with and aligned with the slide slot 232 in the radial direction for receiving the compression spring 233. The compression spring 233 extends in the radial direction, and has a spring end retained in the spring receiving chamber 1911 and an opposite spring end abutting against the movable tooth 231 so as to bias the movable tooth 231 toward the striking rod 5 in the radial direction. The pinion 23 further has a stop structure to restrain movement of the movable tooth 231 in the radial direction. In this embodiment, the stop structure includes a stop member 23111 and a flange 239. The stop member 23111 is disposed on the movable tooth 231, projects axially, and has two ends in slidably contact with the radial walls 2321, 2322, respectively, so as to guide the movement of the movable tooth 231 in the radial direction. The flange 239 is formed on and extends from an edge of the radial wall 2322 to be engageable with the stop member 23111 in the radial direction so as to restrain the movement of the movable tooth 231. The spring receiving chamber 1911 may be in the form of a penetrating hole or a blind hole. The stop member 23111 may be in the form of a pin disposed on the movable tooth 231, or a protrusion 23112 (see FIGS. 16 and 17) integrally formed with the movable tooth 231 as a one-single piece.

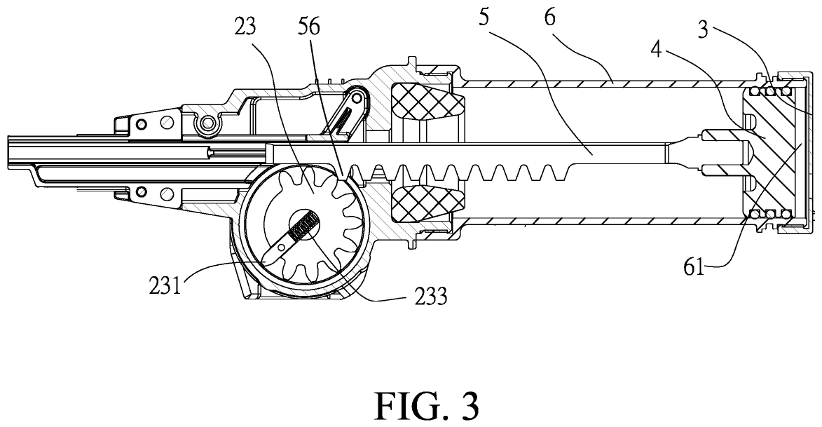

As shown in FIG. 1, when the piston 4 is at the lower piston stop point 36, the movable tooth 231 is engaged with the trailing tooth 55 of the striking rod 5. As shown in FIG. 3, when the leading tooth 56 of the striking rod 5 is engaged with the teeth section of the pinion 23, the piston 4 is spaced apart from an upper cylinder wall 3 of the cylinder 6 by a gap 61 to prevent the piston 4 from being stuck.

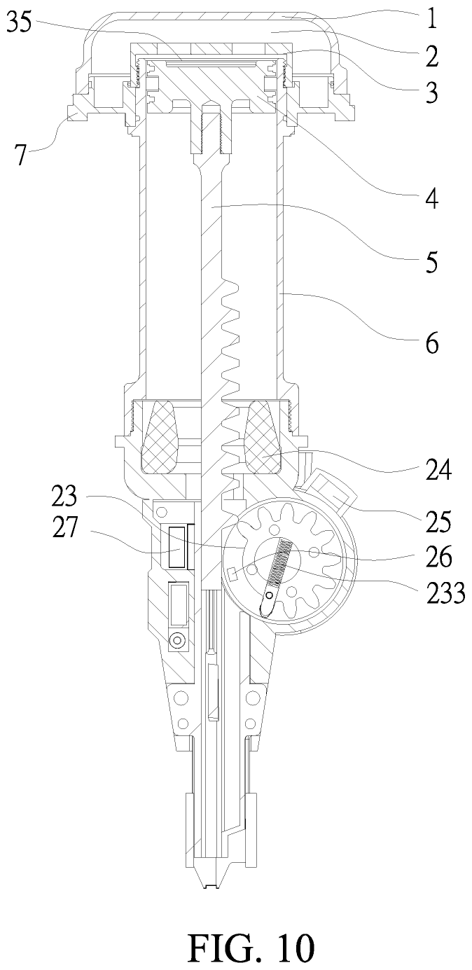

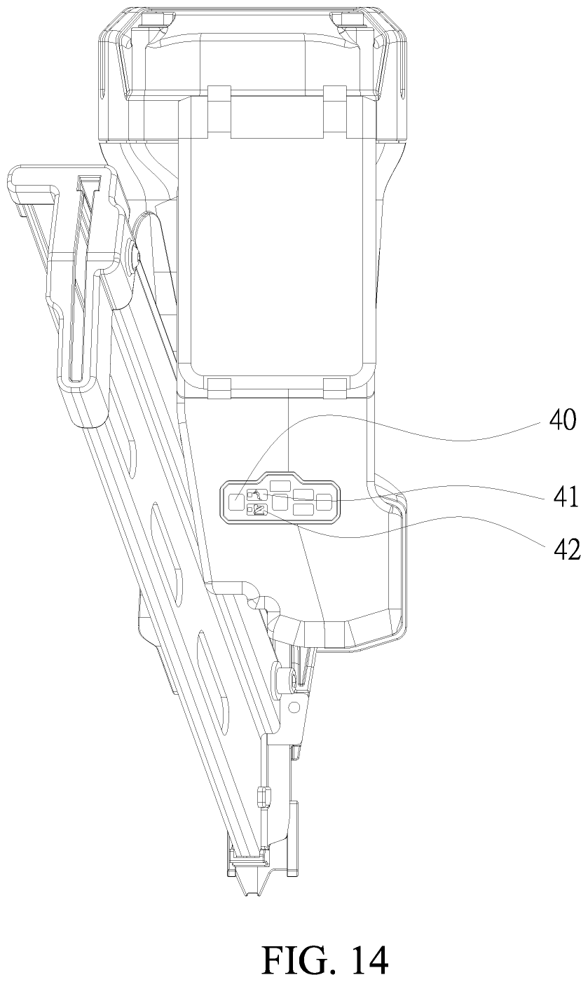

Referring to FIGS. 6, 7, 10 and 11, a sensor device is disposed within the housing to control the movement of the piston 4 between upper and lower piston stop points 35, 36. The sensor device is disposed adjacent to the pinion 23. Specifically, the sensor device includes two hall sensors 25, 27 and a magnet 26. When the piston 4 is at the upper piston stop point 35 (see FIG. 10), one of the hall sensors 25, 27 detects the magnet 26 that is rotated with the pinion 23 to send a signal to an electric circuit for stopping rotation of the motor 19 and hence stopping rotation of the pinion 23. Moreover, the fastener driving tool is shiftable between a fastener driving mode, where the striking rod 5 is permitted to conduct the driving stroke movement, and a gas filling mode, where the driving stroke movement of the striking rod 5 is stopped. As shown in FIG. 14, the fastener driving tool further includes a mold switch button 40 disposed to be operable to shift the fastener driving tool between the fastener driving mode and the gas filling mode, a driving mode indicating light 42 disposed to be turned on when the fastener driving tool is in the fastener driving mode, and a filling mode indicating light 41 disposed to be turned on when the fastener driving tool is in the gas filling mode.

In this embodiment, the gas supply cylinder 11 is disposed within a handle 37 and has a gas source port 38 disposed in an end of the handle 37, as shown in FIG. 6.

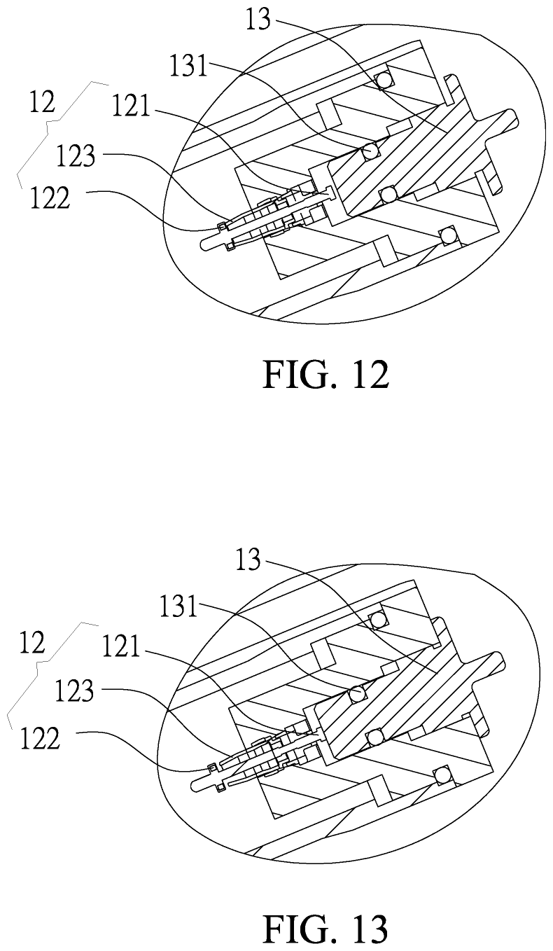

Referring to FIGS. 12 and 13, in the gas source port 38, a valve assembly 12 and a rotary knob 13 are disposed, and a seal ring 131 is disposed for sealing the gas supply cylinder 11. The valve assembly 12 has a valve seat 123, a valve disc 122 movable to close the valve seat 123, and a valve rod 121 extending from the valve disc 122 toward the rotary knob 13. The rotary knob 13 is turnable by an operator to abut against the valve rod 121 to remove the valve disc 122 from the valve seat 123 such that, in this state (see FIG. 13), the gas supply cylinder 11 is closed with the seal ring 131. When the rotary knob 13 is loosened (see FIG. 12), the valve disc 122 is seated on the valve seat 123 so as to seal the gas supply cylinder 11 with the valve assembly 12. Thus, wear of the valve disc 122 by the valve seat 123 can be prevented for a long term use.

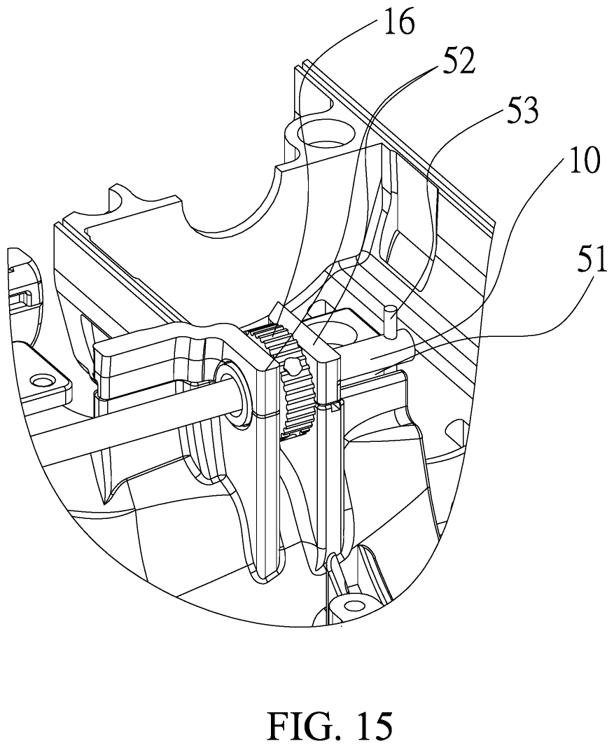

In this embodiment, referring to FIG. 15, the rotary knob 16 is disposed outwardly of the housing to be operated manually. The valve mechanism further includes two positioning plates 52 spaced apart from each other, a pin 53 disposed on an end of the threaded valve rod 10, and a slot 51 for receiving the pin 53. The rotary knob 16 is interposed between the positioning plates 52. The threaded valve rod 10 rotatably extends through the positioning plates 52 and is threadedly engaged with the rotary knob 16. An axial movement of the rotary knob 16 is restricted by the positioning plates 52 and rotation of the threaded valve rod 10 is restricted by the pin 53 and the slot 51 such that rotation of the rotary knob 16 results in axial movement of the threaded valve rod 10.

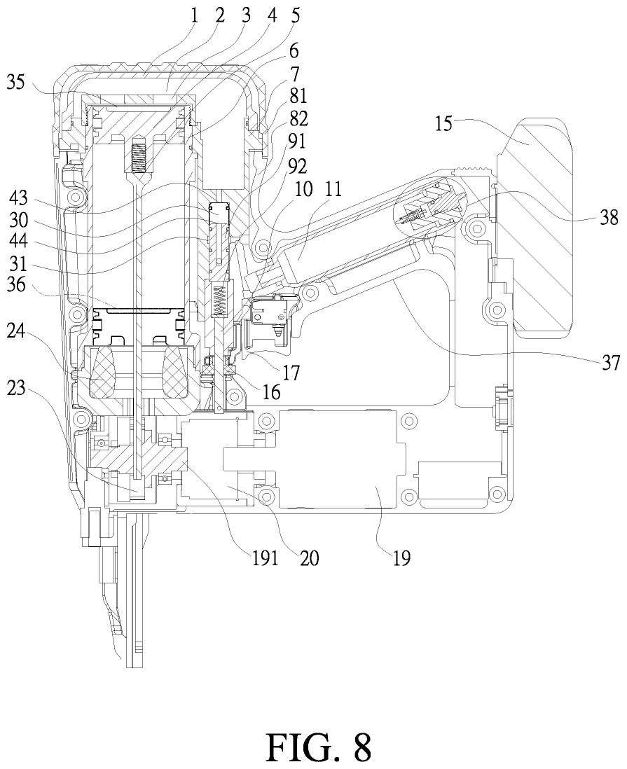

Referring to FIGS. 6 and 8, the housing includes an upper housing body 82, a lower housing body and an upper housing cover 81. A chamber upper cover 1 is disposed inwardly of the upper housing cover 81 to form the gas storage chamber 2 above the cylinder 6. The upper cylinder wall 3 is in the form of a cylinder cover having holes in communication with the gas storage chamber 2. A damping member 24 is disposed in a lower portion of the cylinder 6. The piston 4 is disposed within the cylinder 6, and is movable between the upper piston stop point 35, where the piston 4 is close to the upper cylinder wall 3, and the lower piston stop point 36. A reduction gear assembly 20 is coupled with the output shaft of the motor 19 to transmit the torque from the motor 19 to the driving shaft 191. Further, a battery mounting portion is disposed outwardly of the handle 37 for mounting a battery 15 therein.

In an initial state, the piston 4 is at the upper piston stop point 35, and the motor 19 is stopped such that the striking rod 5 stops the movement in the up-down direction. In a driving state, when a trigger 17 is pulled to drive rotation of the motor 19, the pinion 23 is rotated to bring the non-toothed section into facing the teeth of the striking rod 5 so as not to engage with the striking rod 5 and the striking rod 5 subsequently is moved downward by the compressed gas to conduct the driving stroke movement. In a rod returning state, with rotation of the motor 19, the pinion 23 is rotated to bring the teeth section in engagement with the teeth of the striking rod 5 so as to move the striking rod 5 upwardly back to its driving position, where the piston 4 is at the upper piston stop point 35.

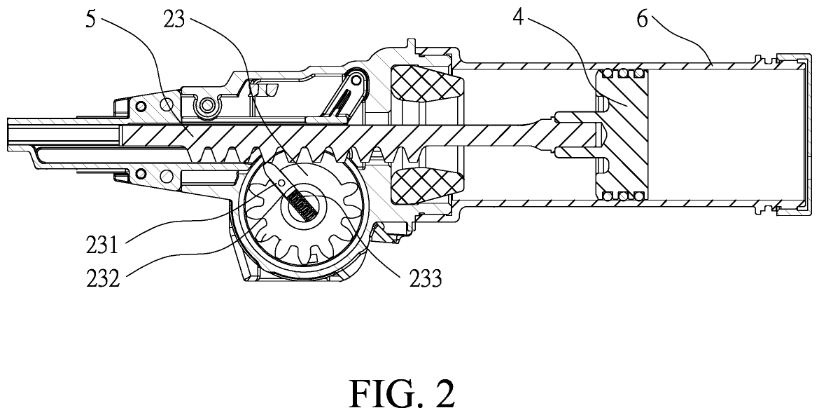

During the driving stroke movement, as shown in FIG. 2, once the striking rod 5 is stuck due to fastener driving failure, with the rod returning mechanism in which the pinion 23 is rotated to engage with and press the movable tooth 231 to retract the movable tooth 231 toward the center of the pinion 23, and the movable tooth 231 is then biased back by means of the compression spring 233 to be engaged with the teeth of the striking rod 5 so as to make a successful mesh engagement with the striking rod 5 and to move the striking rod 5 back to its driving position. Thus, with the movable tooth 231, the pinion 23 can be rotated to smoothly and successfully mesh with the striking rod 5 during usage of the fastener driving tool, which obviates the problems of jamming and malfunction of the striking rod 5.

Further, the compressed gas is filled and stored in the gas storage chamber 2 with a compression that is smaller than 100 PSI in a state when the piston 4 is at the lower piston stop point 36, and a compression that is larger than 130 PSI in a state when the piston 4 is at the upper piston stop point 35.

When it is desired to fill a gas into the gas storage chamber 2, the mode switch button 40 is pushed to shift the fastener driving tool to the gas filling mode, where the filling mode indicating light 41 is turned on, a fastener driving procedure is stopped, and the motor 19 drives rotation of the pinion 23 and is stopped when the non-toothed section of the pinion 23 faces and does not engage with the teeth of the striking rod 5. At this stage, the piston 4 is moved downward to the lower piston stop point 36 and the striking rod 5 is moved downward so as to make a largest working volume of the compressed gas with a smallest pressure. Subsequently, the rotary knob 16 is operated to move the valve rod 10 and the valve 91 upward to open the valve seat of the connecting passage for filling a gas in the gas storage chamber 2. The rotary knob 16 is then operated to bring the valve 91 into blocking the connecting passage.

Next, the mode switch button 40 is pushed to shift the fastener driving tool to the fastener driving mode, where the driving mode indicating light 42 is turned on, and a gas filling procedure is stopped. Subsequently, the trigger 17 is pulled to actuate the motor 19 to drive rotation of the pinion 23 so as to move the striking rod 5 upward to bring the piston 4 into approaching the upper piston stop point 35 such that the fastener driving tool returns back to its initial state.

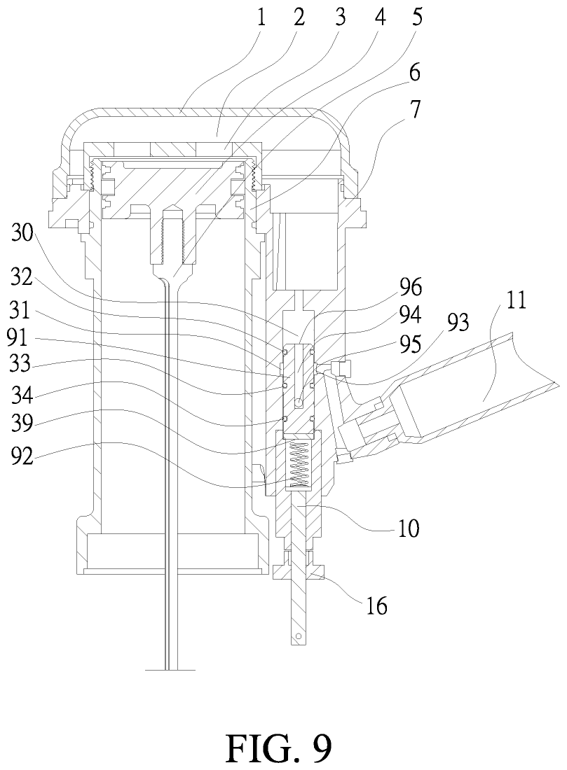

Referring to FIGS. 8 and 9, in an embodiment, a spring 92 is disposed between the valve 91 and the valve rod 10. During the gas filling procedure, the gas pressure in the gas storage chamber 2 is increased to gradually move the valve 91 downward so as to compress the spring 92. Once the gas pressure in the gas storage chamber 2 is larger than a preset pressure, with the compression of the spring and the downward movement of the valve 91, the connecting passage is blocked so as to stop the gas filling procedure to prevent overpressure in the gas storage chamber 2.

In this embodiment, it is appropriate that the gas filling procedure is conducted when the piston 4 is at the lower piston stop point 36. Hence, a suitable and sufficient amount of a compressed gas can be filled for performing the fastener driving procedure with a steady gas pressure and a striking stroke.

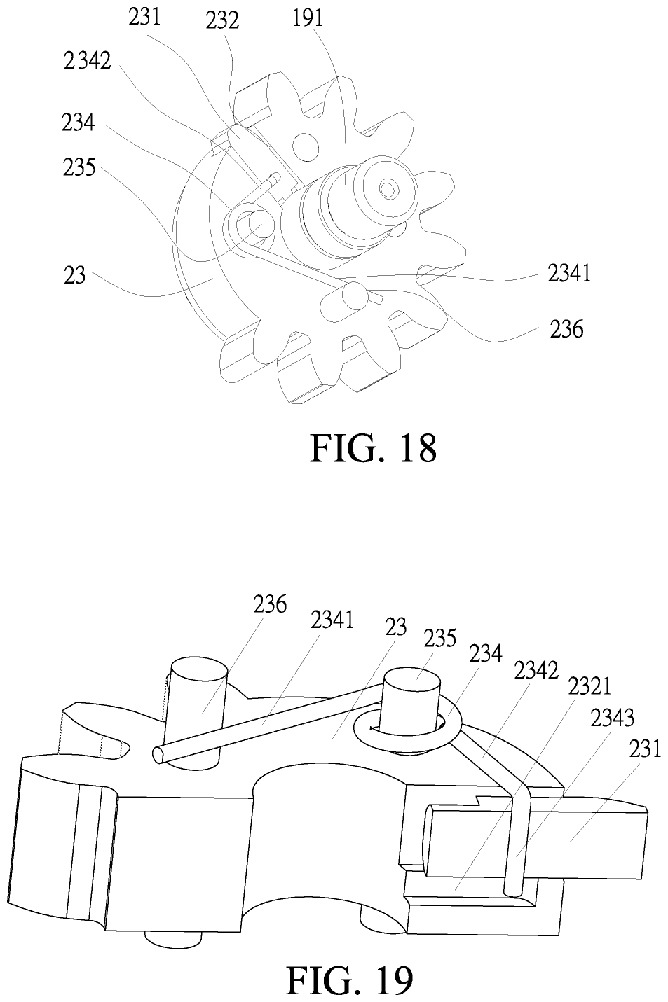

Referring to FIGS. 18 and 19, in an embodiment, the pinion 23 has two positioning pins 235, 236 formed adjacent to the slide slot 232, and a narrow slit 2321 formed in spatial communication with a bottom of the slide slot 232. Instead of having the compression spring, the pinion 23 has a torsion spring 234 which has a coil sleeved on one positioning pin 235, a leg 2341 abutting against the other positioning pin 236, an opposite leg 2342 attached to the movable tooth 231, and a bent end portion 2343 integrally formed with and bent from the opposite leg 2342 and extending axially through the movable tooth 231 into the narrow slit 2321 so as to firmly engage with the movable tooth 231 to prevent removal of the movable tooth 231 from the pinion 23.

As illustrated, with the rod returning mechanism, the striking rod can be successfully returned back to its driving position from any lower position to obviate the problems of jamming and malfunction of the striking rod 5. In the rod returning mechanism, an additional transmitting wheel and a guiding wheel are not required, avoiding increase of the receiving space in the housing to render the structure compact. Moreover, in the embodiment as shown in FIGS. 8 and 9, during the driving stroke movement of the striking rod 5, the valve 91 is not undesirably moved due to variation of the gas pressure, and the spring 92 works steadily. Once in a gas filling operation, only a relatively smaller gas amount or a relatively lower gas pressure is needed.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A fastener driving tool comprising:
a rack-like striking rod extending along an up-down direction and operable by a compressed gas to conduct a driving stroke movement in the up-down direction for driving a fastener into a workpiece, said striking rod having a plurality of teeth arranged along the up-down direction; and
a rod returning mechanism including a motor and a pinion receiving a torque from said motor to rotate about an axis that is transverse to the up-down direction, said pinion having a periphery which includes a teeth section that is engageable with said teeth of said striking rod, and a non-toothed section that is remote from said teeth of said striking rod such that, during the driving stroke movement of said striking rod, said pinion is rotated by said motor to bring said non-toothed section into facing said teeth of said striking rod so as not to engage with said striking rod, and subsequent to permit the driving stroke movement of said striking rod, said pinion being rotatable by said motor to bring said teeth section into engagement with said teeth of said striking rod so as to move said striking rod upwardly back to its driving position, wherein said teeth section having a movable tooth which is resiliently movable in a radial direction relative to the axis.

2. The fastener driving tool as claimed in claim 1, wherein said movable tooth is adjoined to said non-toothed section, said pinion having a slide slot in which said movable tooth is received and slidable in the radial direction.

3. The fastener driving tool as claimed in claim 2, wherein said pinion has a compression spring or a torsion spring attached to said movable tooth to bias said movable tooth toward said striking rod in the radial direction.

4. The fastener driving tool as claimed in claim 3, wherein said pinion has two positioning pins formed adjacent to said slide slot, and a narrow slit formed in spatial communication with a bottom of said slide slot, said pinion having said torsion spring which has a coil sleeved on one of said positioning pins, a leg abutting against the other one of said positioning pins, an opposite leg attached to said movable tooth, and a bent end portion integrally formed with and bent from said opposite leg and extending through said movable tooth into said narrow slit.

5. The fastener driving tool as claimed in claim 3, wherein said pinion has said compression spring extending in the radial direction and having a spring end retained in said pinion, and an opposite spring end abutting against said movable tooth so as to bias said movable tooth toward said striking rod in the radial direction, said pinion having a stop structure to restrain movement of said movable tooth in the radial direction.

6. The fastener driving tool as claimed in claim 5, wherein said rod returning mechanism includes a driving shaft on which said pinion is mounted to serve as the axis of said pinion, said driving shaft having a spring receiving chamber for receiving said compression spring, said stop structure including a stop member disposed on said movable tooth and projecting axially, and a flange formed on said pinion to be engageable with said stop member in the radial direction so as to restrain the movement of said movable tooth.

7. The fastener driving tool as claimed in claim 6, wherein said pinion has two radial walls which extend in the radial direction to define therebetween said slide slot that is in spatial communication and aligned with said spring receiving chamber for receiving said movable tooth, said stop member having two ends which are in slidably contact with said radial walls, respectively, so as to guide the movement of said movable tooth in the radial direction, said flange extending from an edge of one of said radial walls.

8. The fastener driving tool as claimed in claim 1, further comprising a cylinder filled with the compressed gas, and a piston movable by the compressed gas and connected with said striking rod to conduct the driving stroke movement, said striking rod having a leading tooth disposed remote from said piston such that, when said leading tooth is engaged with said teeth section of said pinion, said piston is spaced apart from an upper cylinder wall of said cylinder by a gap.

9. The fastener driving tool as claimed in claim 8, further comprising a driving mechanism including a gas storage chamber in which the compressed gas is filled and forced into said cylinder to conduct the driving stroke movement of said striking rod, the compressed gas being filled and stored in said gas storage chamber with a compression that is smaller than 100 PSI in a state when said piston is at a lower piston stop point, and a compression that is larger than 130 PSI in a state when said piston is at an upper piston stop point.

10. The fastener driving tool as claimed in claim 9, wherein said fastener driving tool is shiftable between a fastener driving mode, where said striking rod is permitted to conduct the driving stroke movement, and a gas filling mode, where the driving stroke movement of said striking rod is stopped, said fastener driving tool further comprising a mold switch button disposed to be operable to shift said fastener driving tool between the fastener driving mode and the gas filling mode, a driving mode indicating light disposed to be turned on when said fastener driving tool is in the fastener driving mode, and a filling mode indicating light disposed to be turned on when said fastener driving tool is in the gas filling mode.
